(19) United States
(12) Patent Application Publication
(10) Pub. No.: US 2024/0421380 A1
(43) Pub. Date: Dec. 19, 2024

(54) COOLING SYSTEM FOR COOLING A HIGH-VOLTAGE BATTERY FOR USE IN A MOTOR VEHICLE

(71) Applicant: Dr. Ing. h.c. F. Porsche Aktiengesellschaft, Stuttgart (DE)

(72) Inventors: Michael ENGLMEIER, Lenting (DE); Tobias RAPP, Weissach (DE); Steffen KOENIG, Ehningen (DE)

(21) Appl. No.: 18/735,282

(22) Filed: Jun. 6, 2024

(30) Foreign Application Priority Data
Jun. 15, 2023 (DE) 10 2023 115 590.3

(51) Int. Cl. H01M 10/6569; H01M 10/613; H01M 10/625; H01M 10/6556

(52) U.S. Cl. CPC H01M 10/6569; H01M 10/613; H01M 10/625; H01M 10/6556

(57) ABSTRACT

A cooling system for cooling a high-voltage battery in a motor vehicle, the system including a first cooling circuit having a single-phase cooling medium configured for direct cooling of a cell module of the high-voltage battery and an ambient heat exchanger configured for delivery of thermal energy of the single-phase cooling medium to an environment. The cooling system further includes a second cooling circuit having a two-phase cooling medium, an ambient heat exchanger configured for delivering thermal energy of the two-phase cooling medium to the environment and a further heat exchanger configured for receiving thermal energy of the single-phase cooling medium. The two-phase cooling medium is fluorine-free, and the second cooling circuit is depressurized.

### CROSS REFERENCE TO RELATED APPLICATIONS

This application claims benefit to German Patent Application No. DE 10 2023 115 590.3, filed on Jun. 15, 2023, which is hereby incorporated by reference herein.

### FIELD

The present invention relates to a cooling system for cooling a high-voltage battery for use in a motor vehicle, a directly cooled high-voltage battery having such a cooling system, and a motor vehicle comprising such a cooling system or such a directly cooled high-voltage battery.

### BACKGROUND

The ongoing development of ever higher energy densities and power outputs of electrical energy stores also requires a continuous increase in the heat energy that can be dissipated per time. In order to dissipate the heat energy from high-performance high-voltage batteries, direct cooling via dielectric media has now established itself, which is applied directly to the cells and can dissipate larger amounts of heat in a short time by direct contact.

The disadvantage is that the heat capacity of the dielectric media used is limited, so that very high volume flow rates are often required for effective heat dissipation, which are either not technically possible or can only be ensured with very high design and energy costs.

In order to solve the problem of a limited heat capacity, special dielectric coolants have been developed that have a high heat capacity in a phase transition, wherein the high heat capacity can be utilized for effective cooling.

The disadvantage is that the known special dielectric coolants are exclusively substances that contain fluorine, which prohibits their use in vehicles in view of the current discussion on perfluorinated and polyfluorinated alkyl substances, which are harmful to health and environment. In addition, the use of two-phase cooling media is a safety concern due to the phase transition and the pressure increase associated with a boiling process.

### SUMMARY

In an embodiment, the present disclosure provides a cooling system for cooling a high-voltage battery for a motor vehicle, the system comprising a first cooling circuit having a single-phase cooling medium configured for direct cooling of a cell module of the high-voltage battery and an ambient heat exchanger configured for delivery of thermal energy of the single-phase cooling medium to an environment. The cooling system further comprises a second cooling circuit having a two-phase cooling medium, an ambient heat exchanger configured for delivering thermal energy of the two-phase cooling medium to the environment and a further heat exchanger configured for receiving thermal energy of the single-phase cooling medium. The two-phase cooling medium is fluorine-free, and the second cooling circuit is depressurized.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a directly cooled high-voltage battery according to a first example embodiment of the present invention; and

FIG. 2 illustrates a motor vehicle with a high-voltage battery according to an embodiment of the invention.

### DETAILED DESCRIPTION

An embodiment of the present invention at least partially remedies the disadvantages described hereinabove. In particular, an embodiment of the present invention provides a cooling system for cooling a high-voltage battery for use in a motor vehicle, which can be operated safely from a health, ecological and safety point of view and enables quick and effective heat dissipation of even larger amounts of heat.

The foregoing is achieved by a cooling system according to the present disclosure, a directly cooled high-voltage battery according to the present disclosure, and a motor vehicle according to the present disclosure. Technical features and details that are disclosed in connection with the cooling system according to embodiments of the invention naturally also apply in connection with the directly cooled high-voltage battery according to embodiments of the invention and the motor vehicle according to embodiments of the invention, and vice versa, so that reference is or can always be mutually made with respect to the disclosure regarding the individual aspects of the invention.

Provided according to an embodiment of the invention is a cooling system for cooling a high-voltage battery for use in a motor vehicle. The cooling system according to an embodiment of the invention comprises a first cooling circuit having a single-phase cooling medium for direct cooling of a cell module of the high-voltage battery and an ambient heat exchanger for delivering thermal energy of the single-phase cooling medium to the environment, a second cooling circuit having a two-phase cooling medium, an ambient heat exchanger for delivering thermal energy of the two-phase cooling medium to the environment and a further heat exchanger for receiving thermal energy of the single-phase cooling medium, whereby the two-phase cooling medium is fluorine-free and the second cooling circuit is depressurized.

According to an embodiment of the present invention, the cooling system is thus designed to enable quick and effective heat dissipation of even larger amounts of heat, in particular by the arrangement of a first cooling circuit having a single-phase cooling medium for direct cooling of a cell module of a high-voltage battery and a second cooling circuit having a two-phase cooling medium for cooling the single-phase cooling medium. Given that the two-phase cooling medium is fluorine-free, and the second cooling circuit is depressurized it is also possible to operate the cooling system according to embodiments of the invention without health, environmental or safety concerns.

According to an embodiment of the present invention, it has been recognized that, by decreasing a pressure within a second cooling circuit, fluorine-free two-phase cooling media can also be used that would not be usable at atmospheric pressure because it would then not have a suitable phase transition.

According to an embodiment of the present invention, a two-phase cooling medium can be understood to mean a coolant that is present in two different phases, preferably in liquid and gaseous form, during a complete cycle of the cooling circuit. The two-phase cooling medium can in this case preferably be a phase change material. Phase change materials are substances that can transition from a solid to a liquid or gaseous state at certain temperatures while absorbing (or releasing) large amounts of heat. Accordingly, a single-phase cooling medium can be understood to mean a coolant that is present in only one phase, preferably in a liquid or gaseous form, during a complete cycle of the cooling circuit. In the context of embodiments of the invention, depressurized can preferably be understood to mean that the pressure within the second cooling circuit is below atmospheric pressure and preferably below the pressure of the first cooling circuit. Preferably, the pressure within the second cooling circuit can measure less than 500 mbar, in particular less than 100 mbar. Direct cooling can preferably be understood to mean a process for directly cooling a medium without the use of an intermediate medium, e.g. water or air. Fluorine-free can in the present context be understood to mean that the medium does not comprise any fluorine components. It is understood that it is in this case preferable to avoid inevitable impurities.

With regard to a structurally simple and cost-effective design for reliably conveying a single-phase and two-phase cooling medium, it can be advantageous according to an embodiment of the invention if the first cooling circuit comprises a pump for conveying the single-phase cooling medium within the first cooling circuit, and the second cooling circuit comprises a pump for conveying the two-phase cooling medium within the second cooling circuit, whereby the pump of the second cooling circuit preferably has a higher flow rate than the pump of the first cooling circuit. The higher flow rate of the second pump can preferably be used to generate a lower pressure within the second cooling circuit, which can induce a phase change of a selected two-phase coolant, or increase the selection of usable two-phase cooling media.

In order to reliably prevent a line system from bursting or components of the cooling system from being damaged in the event of a phase change from liquid to gaseous, it can advantageously be provided that the second cooling circuit comprises a pressure expansion tank with a pressure equalization membrane to ensure a pressure equalization, whereby the pressure expansion tank is preferably arranged between the further heat exchanger and the ambient heat exchanger.

With regard to particularly effective cooling by means of a two-phase cooling medium, it can advantageously be provided that the two-phase cooling medium comprises a phase-change material or is formed from a phase change material, whereby the phase change material is preferably in the form of a salt, and/or a paraffin, and/or in the form of a glycol compound, and/or in the form of water. With regard to the particularly fast absorption of larger amounts of heat, it can further be advantageous if the phase change material is in the form of a salt and/or a paraffin and/or in the form of a glycol compound. All of the materials specified are characterized by a high latent heat and are predestined for certain temperature ranges. Paraffins are also durable and stable. Salts typically have a very high latent heat and are suitable for higher temperatures. Glycol compounds, e.g. polyethylene glycol or polypropylene glycol, are also biodegradable and non-toxic.

In the context of a particularly fast and effective dissipation of heat from the single-phase cooling medium, it can further be of advantage in the present case that the further heat exchanger is designed in the form of a tubular heat exchanger or a capillary heat exchanger. A capillary heat exchanger can preferably comprise a plurality of microchannels for the two-phase cooling medium to pass through. It is to be understood that a hybrid model can also be provided between a tubular heat exchanger or/and a capillary heat exchanger.

For a particularly effective heat transfer and corresponding fast cooling of the single-phase cooling medium, it can preferably be provided that the single-phase cooling medium is in direct contact with the further heat exchanger. Preferably, the single-phase cooling medium can fully flow around the further heat exchanger.

In the context of a particularly fast and effective dissipation of heat from the single-phase and two-phase cooling medium into the environment, it can further be advantageous if the ambient heat exchanger of the first cooling circuit and/or the ambient heat exchanger of the second cooling circuit is in the form of a tubular heat exchanger and/or has a direct connection to a water/glycol cooling circuit. A connection to a water/glycol cooling circuit can advantageously be provided when the cooling system in question is arranged within a motor vehicle because the infrastructure already present within a motor vehicle can be advantageously used.

In an embodiment, the invention is also a directly cooled high-voltage battery for use in a motor vehicle. In this case, the directly cooled high-voltage battery according to an embodiment of the invention comprises a high-voltage battery having a cell module and a module housing arranged around the cell module as well as a cooling system described above. Therefore, the directly cooled high-voltage battery according to an embodiment of the invention offers the same advantages as have been described in detail hereinabove with respect to the cooling system according to embodiments of the invention.

As part of a design for effective cooling of a directly cooled high-voltage battery that is easy to manufacture, it can advantageously be provided according to an embodiment of the invention that the module housing has feedthroughs for introducing and removing the single-phase and two-phase cooling medium, whereby the directly cooled high-voltage battery is configured such that the single-phase cooling medium can be guided directly past the cell module within the module housing. The feedthroughs are preferably arranged in the floor region of the module housing and the cell module is arranged within the module housing, such that the single-phase cooling medium is guided directly past the cell module within the module housing.

With regard to a design for effective cooling of a directly cooled high-voltage battery according to an embodiment of the present invention that is easy to manufacture, it can be advantageously further provided that the further heat exchanger is arranged within the module housing, whereby the further heat exchanger and the cell module are arranged within the module housing, such that the single-phase cooling medium can flow around it.

An embodiment of the invention is also a motor vehicle, in particular an at least partially electrically operated motor vehicle (hybrid vehicle or electric vehicle), having a cooling system as described above, in particular a directly cooled high-voltage battery as described hereinabove. Therefore, a motor vehicle according to an embodiment of the invention has the same advantages as already extensively described with respect to the cooling system according to embodiments of the invention or the directly cooled high-voltage battery according to embodiments of the invention.

Further advantages, features, and details of embodiments of the invention arise from the following description, in which exemplary embodiments of the invention are described in detail with reference to the drawings. The features mentioned in the present disclosure can be essential to the invention individually or in any combination.

The figures are shown schematically.

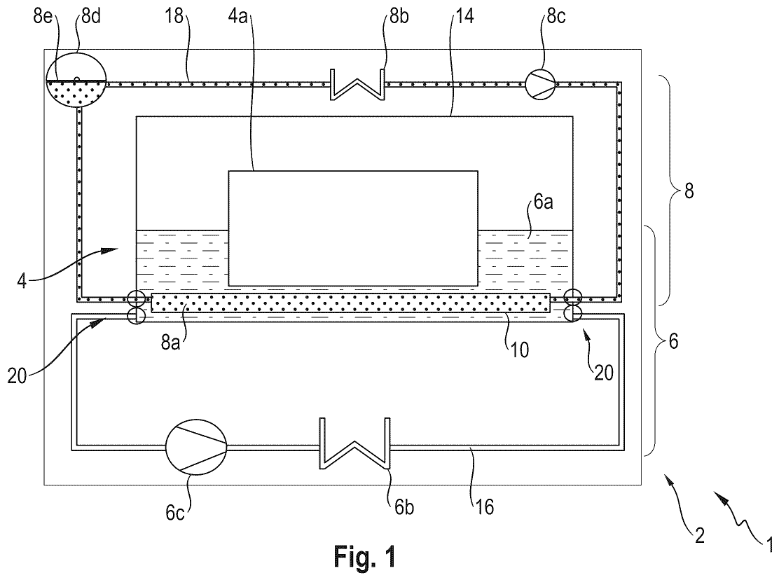

FIG. 1 shows a directly cooled high-voltage battery 1 according to a first example embodiment of the present invention.

As can be seen in FIG. 1, the directly cooled high-voltage battery 1 according to an embodiment of the invention comprises a high-voltage battery 4 having a cell module 4a and a module housing 14 arranged around the cell module 4a, as well as a cooling system 2 for cooling the high-voltage battery 4.

The cooling system 2 further comprises a first cooling circuit 6 having a line system 16, a single-phase cooling medium 6a for direct cooling of the cell module 4a of the high-voltage battery 4 and an ambient heat exchanger 6b for delivering thermal energy of the single-phase cooling medium 6a to the environment, a second cooling circuit 8 having a line system 18, a two-phase cooling medium 8a, an ambient heat exchanger 8b for delivering thermal energy of the two-phase cooling medium 8a to the environment and a further heat exchanger 10 for receiving thermal energy of the single-phase cooling medium 6a, whereby the two-phase cooling medium 8a is fluorine-free and the second cooling circuit 8 is depressurized.

The first cooling circuit 6 also comprises a pump 6c for conveying the single-phase cooling medium 6a within the first cooling circuit 6 and the second cooling circuit 8 comprises a pump 8c for conveying the two-phase cooling medium 8a within the second cooling circuit 8.

It can further be seen that the second cooling circuit 8 comprises a pressure expansion tank 8d with a pressure equalization membrane 8e for ensuring pressure equalization that is arranged between the further heat exchanger 10 and the ambient heat exchanger 8b.

The further heat exchanger 10 can preferably be designed in the form of a pipe heat exchanger or a capillary heat exchanger.

In the present case, the single-phase cooling medium 6a is in direct contact with the further heat exchanger 10.

The ambient heat exchanger 6b of the first cooling circuit 6 and the ambient heat exchanger 8b of the second cooling circuit 8 can also be in the form of a tubular heat exchanger and can, e.g., have a direct connection to a water/glycol cooling circuit.

In addition, it can be seen that the module housing 14 comprises feedthroughs 20 for introducing and removing the single-phase and two-phase cooling medium 6a, 8a, which are arranged such that the single-phase cooling medium 6a is guided directly past the cell module 4a within the module housing 14.

The further heat exchanger 10 is also arranged within the module housing 14 and the single phase cooling medium 6a flows around it.

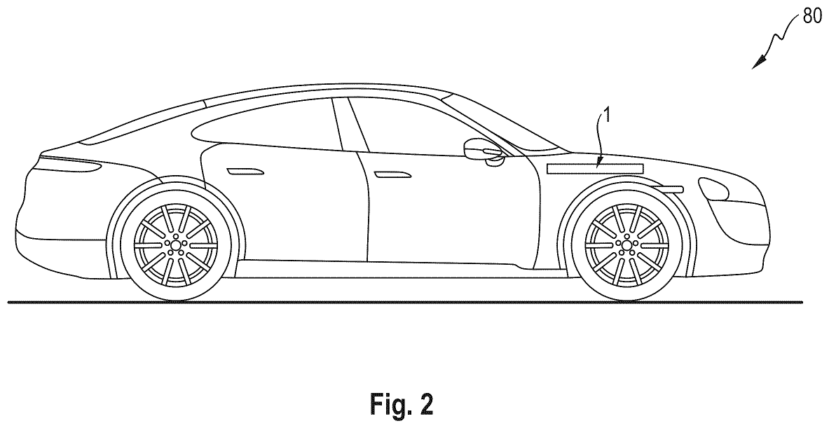

FIG. 2 shows a motor vehicle 80 with a high-voltage battery 1 according to an embodiment of the invention.

The above explanation of the embodiments describes the present invention solely in the context of examples. Of course, individual features of the embodiments can be freely combined with one another insofar as they are technically advantageous without leaving the scope of the present invention.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A cooling system for cooling a high-voltage battery for a motor vehicle, the system comprising:
a first cooling circuit having a single-phase cooling medium configured for direct cooling of a cell module of the high-voltage battery and an ambient heat exchanger configured for delivery of thermal energy of the single-phase cooling medium to an environment; and
a second cooling circuit having a two-phase cooling medium, an ambient heat exchanger configured for delivering thermal energy of the two-phase cooling medium to the environment and a further heat exchanger configured for receiving thermal energy of the single-phase cooling medium,
wherein the two-phase cooling medium is fluorine-free, and the second cooling circuit is depressurized.

2. The cooling system according to claim 1, wherein the first cooling circuit comprises a pump for conveying the single-phase cooling medium within the first cooling circuit, and the second cooling circuit comprises a pump for conveying the two-phase cooling medium within the second cooling circuit.

3. The cooling system according to claim 1, wherein the second cooling circuit comprises a pressure expansion tank having a pressure equalization membrane configured to ensure pressure equalization.

4. The cooling system according to claim 1, wherein the two-phase cooling medium comprises a phase change material or is made of a phase change material.

5. The cooling system according to claim 1, wherein the further heat exchanger is configured in the form of a tubular heat exchanger or a capillary heat exchanger.

6. The cooling system according to claim 1, wherein the single-phase cooling medium is in direct contact with the further heat exchanger.

7. The cooling system according to claim 1, wherein the ambient heat exchanger of the first cooling circuit and/or the ambient heat exchanger of the second cooling circuit is configured in the form of a tubular heat exchanger and/or has a direct connection to a water/glycol cooling circuit.

8. A directly cooled high-voltage battery for a motor vehicle, comprising:
a high-voltage battery having a cell module and a module housing arranged around the cell module; and
the cooling system according to claim 1.

9. The directly cooled high-voltage battery according to claim 8, wherein the module housing comprises feedthroughs for introducing and removing the single-phase and two-phase cooling medium, and wherein the directly cooled high-voltage battery is configured such that the single-phase cooling medium can be guided directly past the cell module within the module housing.

10. The directly cooled high-voltage battery according to claim 8, wherein the further heat exchanger is arranged within the module housing, wherein the further heat exchanger and the cell module are arranged within the module housing such that the single-phase cooling medium can flow around it.

11. A motor vehicle comprising the cooling system according to claim 1.

12. The cooling system according to claim 2, wherein the pump of the second cooling circuit has a higher flow rate than the pump of the first cooling circuit.

13. The cooling system according to claim 3, wherein the pressure expansion tank is arranged between the further heat exchanger and the ambient heat exchanger.

14. The cooling system according to claim 4, wherein the phase change material is in the form of a salt, and/or a paraffin, and/or in the form of a glycolic compound, and/or in the form of water.
